(19) United States
(12) Patent Application Publication
(10) Pub. No.: US 2011/0051997 A1
(43) Pub. Date: Mar. 3, 2011

(54) APPARATUS FOR DETERMINING STATE OF STACKED SHEETS, SHEET HANDLING APPARATUS AND METHOD FOR DETERMINING STATE OF STACKED SHEETS

(75) Inventors: Takahisa Nakano, Kanagawa-ken (JP); Tsutomu Saito, Kanagawa-ken (JP)

(73) Assignee: KABUSHIKI KAISHA TOSHIBA, Tokyo (JP)

(21) Appl. No.: 12/868,910

(22) Filed: Aug. 26, 2010

(30) Foreign Application Priority Data
Sep. 3, 2009 (JP) 2009-204079

(51) Int. Cl. G06K 9/00

(52) U.S. Cl. 382/100

(57) ABSTRACT

In an embodiment, an apparatus for determining a state of stacked sheets composed of a plurality of sheets loaded on a table in a standing state includes an illumination unit to irradiate a slit light to an end face composed of side faces of the stacked sheets, a light receiving portion to receive a reflection light of the slit light irradiated by the illumination unit and reflected from the stacked sheets, a detecting unit to detect edges of the sheets based on the reflection light that is reflected from the stacked sheets and received by the light receiving portion, and a determination unit to determine a state of the stacked sheets based on the edges detected by the detecting unit.

### CROSS-REFERENCE TO RELATED APPLICATION

This application is based upon and claims the benefit of priority from Japanese Patent Application No. 2009-204079, filed on Sep. 3, 2009, the entire contents of which are incorporated herein by reference.

### FIELD

Exemplary embodiments described herein relate to an apparatus for determining a state of stacked sheets, a sheet handling apparatus and a method for determining state of stacked sheets.

### BACKGROUND

In a conventional sheet handling apparatus, stacked sheets are supplied to a table in standing state, and are conveyed to a take out position by a conveyor belt. The sheets conveyed to the take out position at the end of the conveying path are taken out by the take out apparatus in the face direction of the sheets one by one.

A density of the sheets is determined in the vicinity of the take out apparatus, and a conveying speed of the conveyor belt is controlled according to the density. With respect to one to determine the density of the stacked sheets, a linear CCD sensor or a CCD camera is used which is arranged in the vicinity of the take out position by the take out apparatus. And a one-dimensional or two-dimensional image data of the sheets to be conveyed is obtained by the linear CCD sensor or the CCD camera. By detecting dark/light information of the amount of light per one-dimensional pixel based on the obtained image data, or by detecting dark/light information of the amount of light based on the brightness and chromaticity information from the two-dimensional image data, the density of the sheets is determined. That is, a case where there are more dark areas is more in the dark/light information is determined as “loose”, that is, as having a low density, and a case where there are more that the light areas is more in the dark/light information is determined as “dense”, that is, as having a high density. In other words, in the present specification, “density of the sheets” thus refers to the degree of density of a stack of sheets, and a stack of sheets without or with few gaps between the sheets can be described as “dense” and a stack of sheets with many or large gaps between the sheets can be described as “loose”.

The conventional apparatus for determining the state of the stacked sheets detects the dark/light information of the amount of the light of the reflection light from the light irradiated on the sheets, and determines the density of the stacked sheets based on the detection result. But the determination of the density based on the detected dark/light information of the amount of the light can not calculate the gaps between the sheets. For the reason, there was a problem that the determination of the density based on the dark/light information lacks the accuracy and the density of the stacked sheets does not correspond to the conveying control, so that the determination lacks in accuracy of taking out the sheets.

In addition, the conventional state apparatus for determining the state of the stacked sheets could not determine the tilting state of the sheets to be conveyed.

### BRIEF DESCRIPTION OF THE DRAWINGS

FIG. 1 is a construction view showing a construction of a sheet handling apparatus according to a first embodiment;

FIG. 2 is a top view of a sheet take out/conveying apparatus according to the first embodiment;

FIG. 3 is a schematic view showing a construction of a detecting unit of the sheet handling apparatus according to the first embodiment;

FIG. 4 is a view showing an enlarged example of an image data based on the light received in a light receiving portion according to the first embodiment;

FIG. 5 is a block diagram of a controller to control a conveying speed of a conveyor belt according to the first embodiment;

FIG. 6 is a flow chart showing processing of the sheet take out/conveying apparatus according to the first embodiment;

FIG. 7 is a view showing an image data after edge processing has been performed on image data of reflection light according to the first embodiment;

FIG. 8 is a graph showing detected coordinates of the bright points and the end points of the bright lines of the reflection lights according to the first embodiment;

FIG. 9 is a schematic perspective view showing a construction of a detecting unit of a sheet handling apparatus according to a second embodiment;

FIG. 10 is a flow chart showing processing of the sheet take out/conveying apparatus according to the second embodiment;

FIG. 11 is a view showing an example of an image date based on the light received in a light receiving portion according to the second embodiment;

FIG. 12 is a view showing an image data after edge processed in an image data of reflection lights according to the second embodiment;

FIG. 13 is a graph showing detected coordinates of the bright points and the end points of the bright lines of the reflection lights according to the second embodiment;

FIGS. 14A and 14B are views each showing the relation among the threshold value, the average value of the tilts of the sheets and the tilting state of the sheets;

FIGS. 15A and 15B are schematic views each showing the relation between the tilting state of the sheets and the conveying speed;

FIG. 16 is a table showing the correlation between the determination result and adjustment of the conveying speed according to the second embodiment;

FIG. 17 is a top view of a sheet take out/conveying apparatus according to a third embodiment;

FIG. 18 is a flow chart showing processing of the sheet take out/conveying apparatus according to the third embodiment;

FIG. 19 is a table showing the correlation among the determination result, the conveying speed of the downstream side supply conveyor belts and the moving speed of the backup plate according to the third embodiment; and

FIGS. 20A and 20B are schematic views each showing the relation among the tilting state of the sheet bundle, the conveying speed of the downstream side supply conveyor belts and the moving speed of the backup plate according to the third embodiment.

### DETAILED DESCRIPTION

In general, according to one embodiment, there is provided an apparatus for determining a state of stacked sheets including: an illumination unit to irradiate a slit light to an end face composed of side faces of the stacked sheets composed of a plurality of sheets loaded on a table in standing state; a light receiving portion to receive a reflection light of the slit light irradiated by the illumination unit from the stacked sheets; a detecting unit to detect edges of the sheets based on the reflection light from the end face out of the reflection light received by the light receiving portion; and a determination unit to determine a state of the stacked sheets based on the edges detected by the detecting unit.

Hereinafter, embodiments of the present invention will be described with reference to the drawings.

### First Embodiment

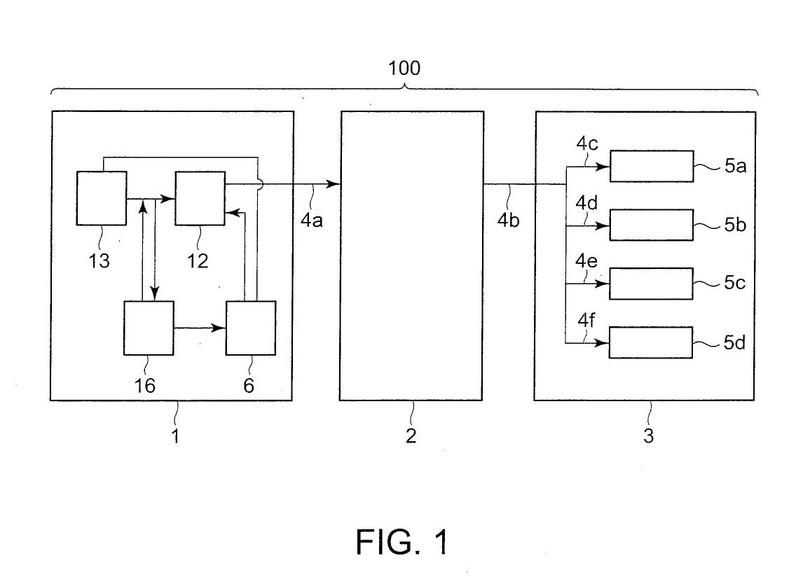

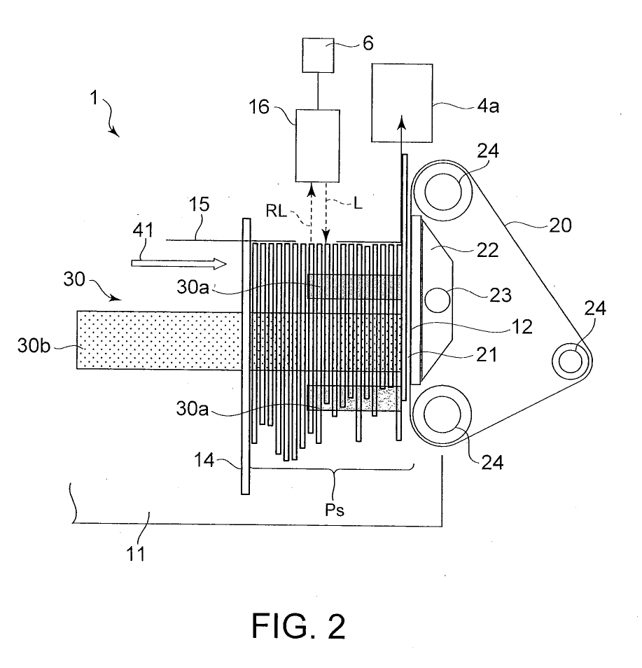

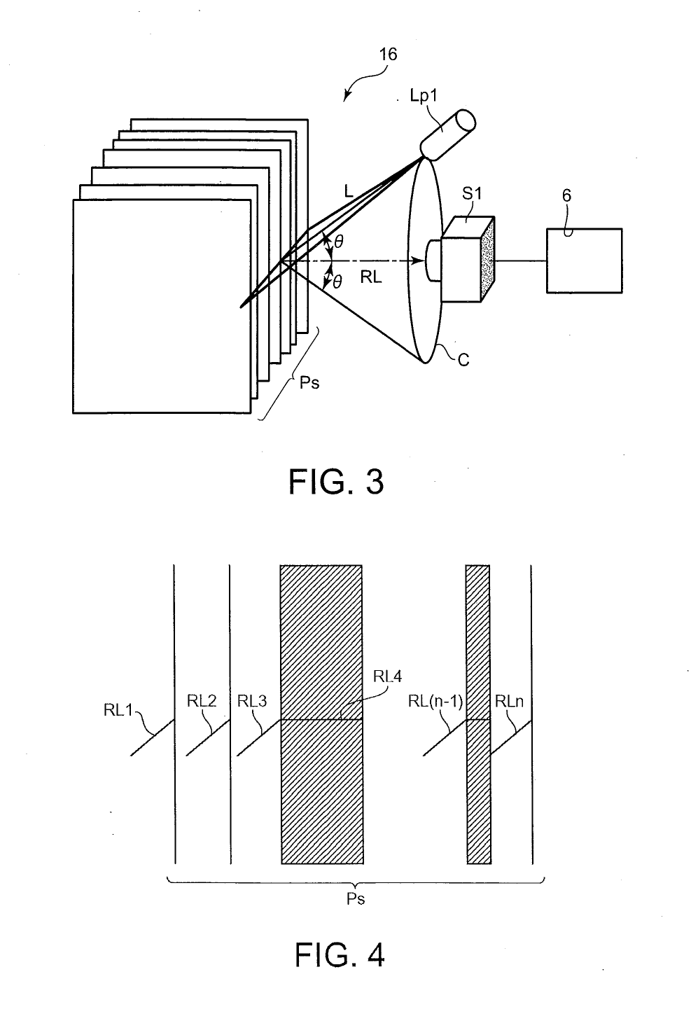

FIG. 1 is a construction view showing a construction of a sheet handling apparatus 100 according to a first embodiment of the present invention. FIG. 2 is a top view of a sheet take out/conveying apparatus 1 according to the first embodiment of the present invention. and FIG. 3 is a schematic view showing a construction of a detecting unit 16 of the sheet handling apparatus 100 according to the first embodiment of the present invention. Hereinafter, the construction of the sheet handling apparatus 100 according to the first embodiment of the present invention will be described using these FIG. 1, FIG. 2 and FIG. 3.

As shown in FIG. 1, the sheet handling apparatus 100 includes the sheet take out/conveying apparatus 1, a sheet data reading apparatus 2 and a sheet classification apparatus 3.

Conveying paths 4a, 4b connect the sheet take out/conveying apparatus 1 and the sheet data reading apparatus 2 as well as the sheet data reading apparatus 2 and the sheet classification apparatus 3, respectively. The conveying path 4b is divided into conveying paths 4c, 4d, 4e and 4f.

The sheet take out/conveying apparatus 1 includes a table 11, a sheet take out device 12, a sheet conveying apparatus 13, a backup plate 14, a detecting unit 16, a separating plate, a separating mechanism and a controller 6, as shown in FIG. 2.

Stacked sheets composed of a plurality of sheets (a sheet bundle Ps) are loaded on the table 11 in standing state. The sheet take out device 12 takes out the sheets one by one from the sheet bundle Ps on the table 11. The sheet conveying apparatus 13 conveys the sheet bundle Ps on the table 11 to the sheet take out device 12 side. The backup plate 14 holds a last sheet out of the sheet bundle Ps and moves the sheet bundle Ps to the sheet take out device 12 side. The detecting unit 16 irradiates a slit light to the sheet bundle Ps and detects a state of the sheet bundle Ps by receiving a reflection light. The separating plate prevents overlapping of sheets when taking out the sheets. The separating mechanism is composed of a friction member. The controller 6 is connected to the detecting unit 16.

A sheet taken out by the sheet take out/conveying apparatus 1 is conveyed through the conveying path 4a to the sheet data reading apparatus 2, where data written on the surface of the sheet such as a post code and a destination address is read out. The sheet from which the data has been read out passes through the conveying path 4b, and passes through any one of conveying paths 4c, 4d, 4e and 4f selected based on the read out data and is sent to any one of sheet stackers 5a, 5b, 5c and 5d which is decided for each of the post codes by the sheet classification apparatus 3.

The sheet take out/conveying apparatus 1 includes the sheet take out device 12, the sheet conveying apparatus 13, the detecting unit 16 and the controller 6.

The sheet take out device 12 is provided at an end of the conveying path of the sheet conveying apparatus 13. The sheet take out device 12 is composed of a sheet take out belt 20 with adsorption holes bored by regular intervals, a chamber mask 21 provided inside the sheet take out belt 20, a vacuum chamber 22 connected to the chamber mask 21, a vacuum contact air duct 23 connected to the vacuum chamber 22, and a plurality of rotation rollers 24 around which the sheet take out belt 20 is wound. The vacuum contact air duct 23 is connected to a vacuum pump.

The sheet conveying device 13 has a conveyor belt 30 composed of conveyors which can be rotated by driving structure described later. The conveyor belt 30 includes downstream side supply conveyor belts 30a (two belts) arranged in the vicinity of the sheet take out belt 20 at a downstream side of a conveying direction 41 and an upstream side supply conveyor belt 30b arranged from the upstream side to the downstream side of the conveying direction 41.

The downstream side supply conveyor belts 30a protrude more above the table 11 than the upstream side feed conveying belt 30b, and the sheets conveyed by the upstream side feed conveying belt 30b are transferred to the downstream side supply conveyor belts 30a and are conveyed.

As the sheet bundle Ps is conveyed along a side wall 15, the sheet bundle Ps is supplied in a state in which one side of the sheet bundle Ps is aligned at the side wall 15 side. A large window is provided in the side wall 15 sufficient so as to irradiate a slit light L or to receive a reflection light RL.

The detecting unit 16 is composed of an illumination unit Lp1 and a light receiving portion S1 as shown in FIG. 3. The detecting unit 16 is arranged at a position where the detecting unit 16 can irradiate the slit light L from the illumination unit Lp1 to an end face composed of the side faces of a plurality of sheets (hereinafter, end face of the sheet bundle Ps) and can receive the reflection light RL from the sheet bundle Ps by the slit light L.

With respect to an irradiation angle of the slit light L in this time, it is preferable to irradiate the slit light L with a prescribed angle (θ shown in FIG. 3, 0°<θ<90° against the end face of the sheet bundle Ps loaded on the table 11. In particular, the prescribed angle is preferable to be 30°. That is, the illumination unit Lp1 irradiates the slit light L from an optional position on a circle C shown in FIG. 3. This is made so as to separate the reflection light reflected from the thickness portion of the sheets included in the reflection light RL except the reflection light from the end face of the sheet bundle Ps. In addition, it is preferable that a wavelength of the light emitted from the illumination unit Lp1 has an emission band in the infrared region. This is because the sheet bundle Ps has possibly various absorption properties in the visible band, and is made to avoid that the irradiated slit light L is absorbed by the sheet bundle Ps and does not reflect. In addition, in case that reflection • absorption bands of the sheets are ascertained preliminarily, the emission wavelength of the illumination unit Lp1 may be selected by avoiding the absorption band.

The light receiving portion S1 receives the reflection light RL from the sheet bundle Ps due to the slit light L irradiated to the sheet bundle Ps by the illumination unit Lp1.

FIG. 4 shows an enlarged example of the image data based on the reflection light RL received at the light receiving portion S1. As the end face of the sheet bundle Ps is aligned, the reflection light at a hatching portion is the reflection light at the end face of the sheet bundle Ps, and in case that the sheets are thick, a long bright line such as RL4 appears in the width direction of the sheets. In addition, the bright line appearing obliquely in the left lower direction in FIG. 4 is a reflection light from the surface of the sheet through a gap between the adjacent sheets.

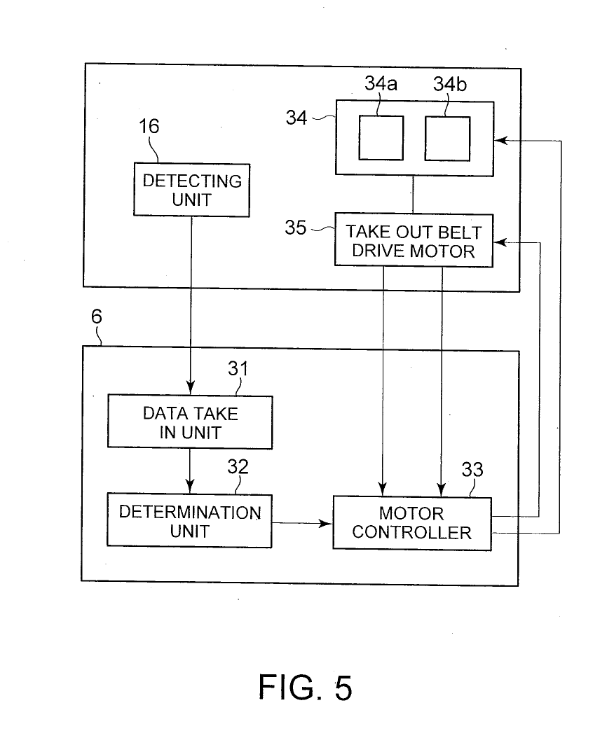

The image data based on the reflection light RL received at the light receiving portion S1 is transmitted from the detecting unit 16 to a data take in unit 31 shown in FIG. 5.

The data take in unit 31 of the controller 6 takes in the above-described image data transmitted from the detecting unit 16, and a distance Gₙ (the value indicates a gap generating between the sheets) between the edges of the adjacent sheets is calculated by executing binarization processing, edge processing and so on (calculation method will be described later in detail). The binarization processing is a processing executed to remove noises included in the image data of the reflection light RL, and the edge processing is a processing to extract an outline of the sheets from the image data.

A determination unit 32 shown in FIG. 5 determines a density of the sheet bundle Ps based on the calculation result.

The determination result (which may take on the values “loose”, “dense”, and “usual” for example) is sent from the determination unit 32 to a motor controller 33. The motor controller 33 controls a rotation speed of a supply conveyor motor 34, and controls a conveying speed of the conveyor belt 30.

The supply conveyor motor 34 is composed of a supply conveyor motor 34a (for downstream side use) and a supply conveyor motor 34b (for upstream side use) so as to control independently the downstream side supply conveyor belt 30a and the upstream side supply conveyor belt 30b composing the conveyor belt 30, respectively. In addition, the motor controller 33 controls a rotation speed of a take out belt drive motor 35 to move the backup plate 14 concurrently.

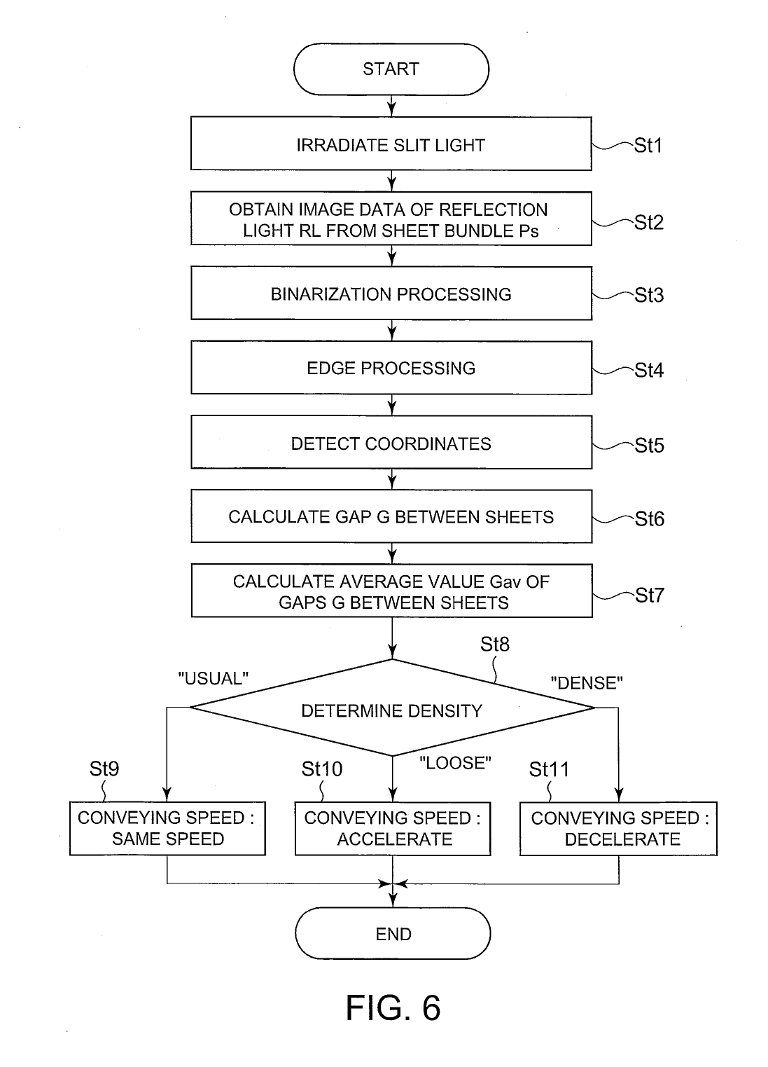

Hereinafter, the determination of the density of the sheet bundle Ps performed by the determination unit 32 will be described with reference to FIG. 6.

FIG. 6 is a flow chart showing processing of the sheet take out/conveying apparatus 1 according to the first embodiment.

The slit light L is irradiated from the illumination unit Lp1 to the end face of the sheet bundle Ps with the aligned end face (St1). When the slit light L is irradiated to the end face of the sheet bundle Ps in St1, the slit light L is reflected by the sheet bundle Ps, and the reflection light RL due to the sheet bundle Ps is inputted to the light receiving portion S1, and an image data (FIG. 4) of the reflection light RL is obtained (St2).

The image data of the reflection light RL obtained by the light receiving portion S1 in St2 is sent to the data take in unit 31 of the controller 6, and is binarization processed in the data take in unit 31 (St3).

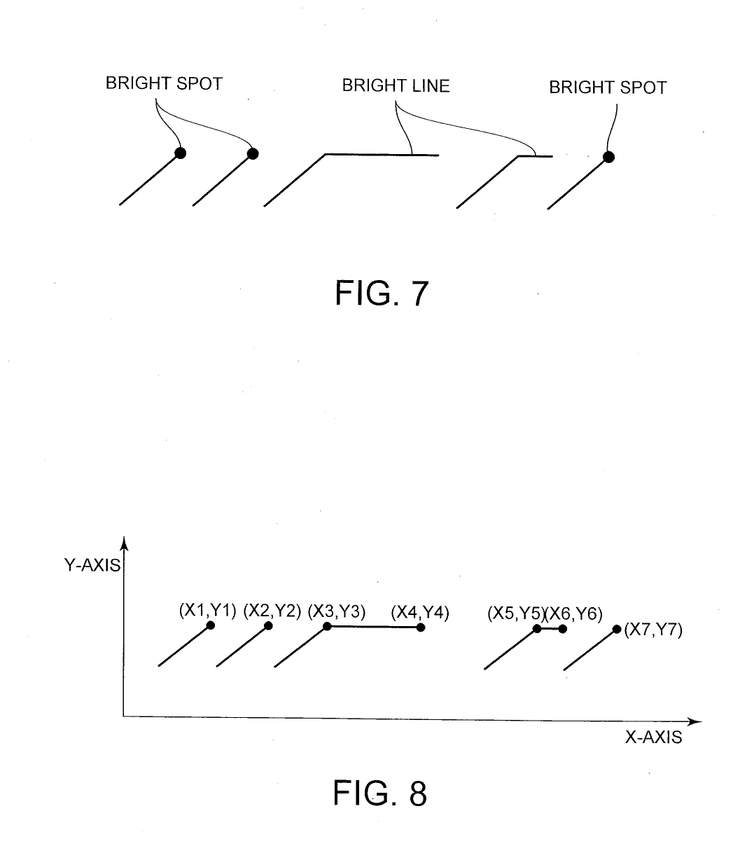

Subsequently, the edge processing is performed in the data take in unit 31 to the image data which is binarization processed in St3 (St4). FIG. 7 is a view showing an image data after the edge processing is performed to the image data of the reflection light RL in St4. The data take in unit 31 detects coordinates of the points (bright points) and end points of the lines (bright lines) which are reflected at the end face of the sheet bundle Ps from the image data which is edge processed in St4 (St5). That is, these bright points and bright lines indicate the reflection lights reflected at the edges of the sheets, respectively. FIG. 8 shows the coordinates of the bright points and the end points of the bright lines detected in St5. Here, with respect to the coordinate axes, an X-axis is taken for a horizontal direction of the image, and a Y-axis is taken for a vertical direction.

Next, distances between adjacent bright points and distances between the bright points and the end points are calculated based on the coordinates of the bright points and the end points of the bright lines of the reflection lights RL detected in St5. The calculated distances between the bright points and distances between the bright lines and the end points are the gaps Gₙ between the adjacent sheets. The gap Gₙ is calculated based on a following expression (expression 1) by the data take in unit 31 (St6). However, the distances between the end points of the bright lines are not calculated.

Gₙ=Xₙ−Xₙ₋₁(n,n:integer) (expression 1)

After St6, the data take in unit 31 calculates an average value Gₐᵥ of the gaps Gₙ between the adjacent sheets of a plurality of the sheets which are calculated in St6 (St7).

Based on the average value Gₐᵥ of the gaps Gₙ between the sheets calculated in St7 and a preliminarily set threshold value Gₜₕ, the determination of the density of the sheet bundle Ps is performed in the determination unit 32 (St8).

In addition, with respect to the determination of the density of the sheet bundle Ps, two threshold values composed of a threshold value Gₜₕ(Hi) and a threshold value Gₜₕ(Low) are set (here, that Gₜₕ(Hi)>Gₜₕ(Low) is assumed), and the determination is made based on the magnitude relation of the calculated average value Gₐᵥ of the gaps between a plurality of sheets and the threshold values Gₜₕ(Hi), Gₜₕ(Low).

That is, a case that the calculated average value Gₐᵥ of the gaps between a plurality of sheets is larger than the threshold value Gₜₕ(Hi) (Gₐᵥ>Gₜₕ(Hi)) is determined as “loose”, a case that the calculated average value Gₐᵥ of the gaps between a plurality of sheets is a value between Gₜₕ(Hi) and Gₜₕ(Low) (Gₜₕ(Hi)>Gₐᵥ>Gₜₕ(Low)) is determined as “usual”, and a case that the calculated average value Gₐᵥ of the gaps between a plurality of sheets is smaller than the threshold value Gₜₕ(Low) (Gₐᵥ<Gₜₕ(Low)) is determined as “dense”.

As a result of the determination in St8, when determined as “loose” (Gₜₕ(Hi)<Gₐᵥ) (St8: “loose”), a conveying speed of the sheet bundle Ps is accelerated (St10). That is, the supply conveyor motor 34a (for downstream side use) and the supply conveyor motor 34b (for upstream side use) are controlled so as to accelerate the downstream side supply conveyor belts 30a and the upstream side supply conveyor belt 30b at the same speed.

On the other hand, as a result of the determination in St8, when determined as “dense” (Gₜₕ(Low)>Gₐᵥ) (St8: “dense”), the conveying speed of the sheet bundle Ps is decelerated (St11). That is, the supply conveyor motor 34a (for downstream side use) and the supply conveyor motor 34b (for upstream side use) are controlled so as to decelerate the downstream side supply conveyor belts 30a and the upstream side supply conveyor belt 30b at the same speed (St11).

In addition, as a result of the determination in St8, when determined as “usual” (St8: “usual”), the supply conveyor motor 34a (for downstream side use) and the supply conveyor motor 34b (for upstream side use) are kept at the present speed (St9).

As described above, the density of the sheet bundle Ps in the vicinity of the sheet take out belt 20 is kept constant by accelerating or decelerating the conveying speed of the sheet bundle Ps according to the density of the sheet bundle Ps, and thereby the amount of the sheets supplied to the sheet take out belt 20 can be made constant and the take out accuracy of the sheets can be raised.

### Second Embodiment

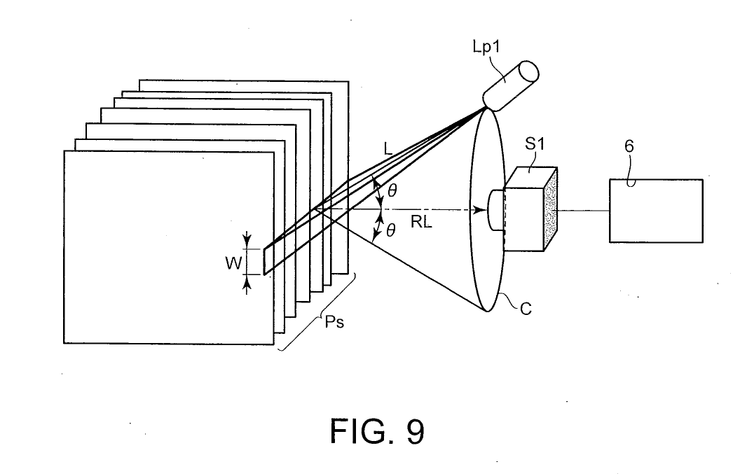

Subsequently, a second embodiment will be described. The second embodiment differs from the first embodiment in a point that the slit light L irradiated from the illumination unit Lp1 has a prescribed width W as shown in FIG. 9. In addition, the same reference numerals are given for the same components of the first embodiment, and the duplicated description will be omitted.

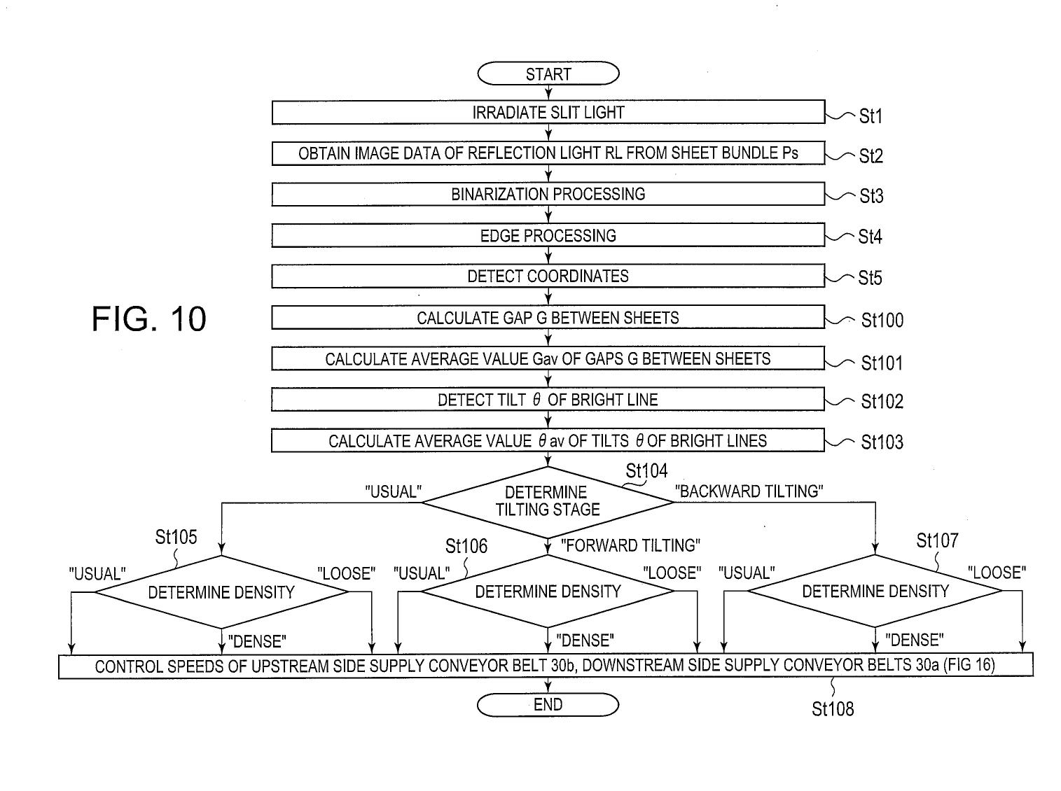

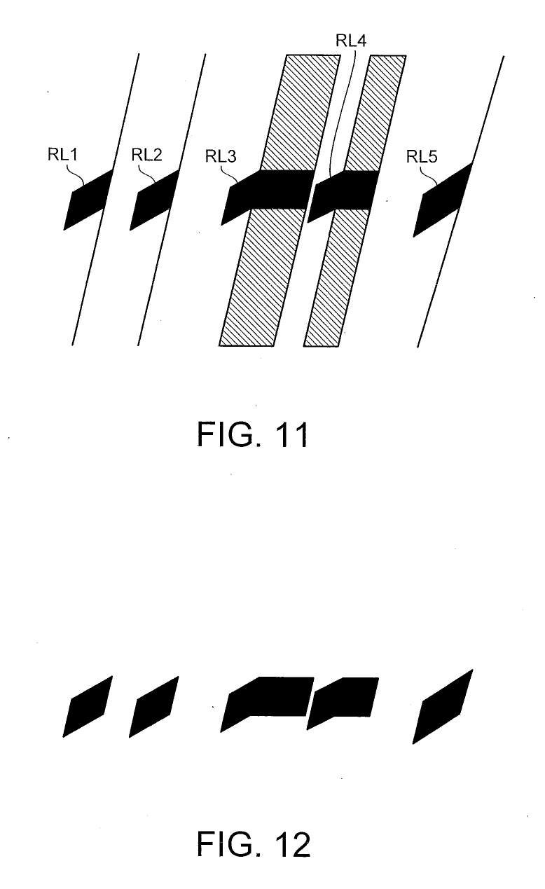

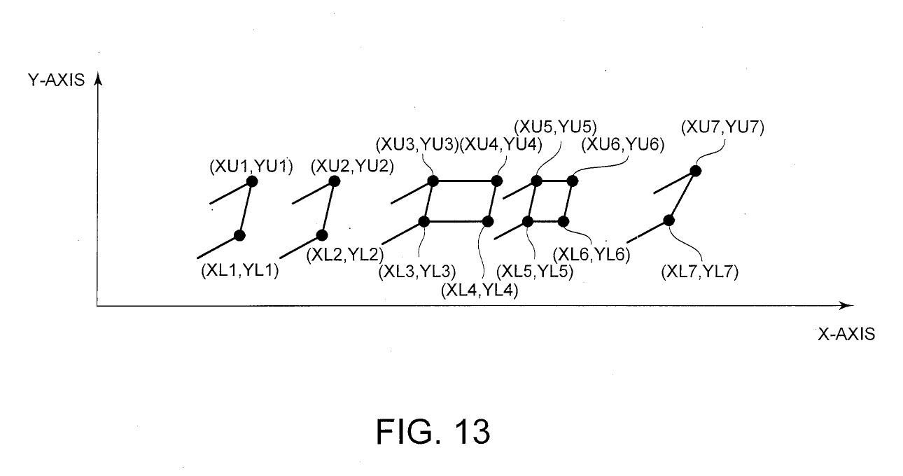

FIG. 10 is a flow chart showing processing of the sheet take out/conveying apparatus 1 according to the second embodiment. With respect to St1 to St5 of the first embodiment, as the processing in the second embodiment are performed in the same processing as shown in FIG. 6, the description will be omitted. But the image data (FIG. 4) obtained in St2 in the first embodiment corresponds to FIG. 11, the image data (FIG. 7) which is edge processed in St4 corresponds to FIG. 12 in the present embodiment, and the image data (FIG. 8) indicating the coordinates of the bright points and the end points of the bright lines of the reflection lights RL detected in St5 corresponds to FIG. 13 in the present embodiment, respectively. Hereinafter, the processing will be described based on FIG. 13.

The detected bright lines of the reflection lights RL at the edges of the sheets shown in FIG. 13 have a vertically long length equal to the width W of the slit light L. Based on the coordinates of the upper end points of these bright lines, the distances between the adjacent end points or the distances between the end points at the both ends and the adjacent end points in case that the bright lines are connected at the upper portions are calculated. These calculated distances between the end points are gaps Gₙ indicating the distances between the sheets. The gap Gₙ is calculated based on a following expression (expression 2) by the data take in unit 31 (St100).

Gₙ=XUₙ−XUₙ₋₁(n,n:integer) (expression 2)

After St100, the data take in unit 31 calculates an average value Gₐᵥ of the gaps between a plurality of the sheets from the gaps Gₙ between the sheets calculated in St100 (St101).

Subsequently, the data take in unit 31 calculates, from the detected coordinates, tilts θₙ of the bright lines of the sheets in the longitudinal direction (the tilts θₙ of the bright lines indicate tilts of the sheets) based on a following expression (expression 3) (St102).

θₙ=(YUₙ−YLₙ)/(XUₙ−XLₙ)(n,n:integer) (expression 3)

After St102, the data take in unit 31 calculates an average value θₐᵥ of the tilts of the bright lines of a plurality of sheets from the calculated tilts θₙ of the bright lines (St103).

After St103, the tilting state of the sheet bundle Ps is determined by comparing the average value θₐᵥ of the tilts calculated by the determination unit 32 with a preliminarily set threshold value θₜₕ, (St104).

Here, with respect to the determination of the tilting state of the sheet bundle Ps, a range of the threshold value θₜₕ of the tilts of the sheets is preliminarily set as θₜₕ=90°±α, the determination is performed according to the magnitude relation between the threshold value θₜₕ and the calculated average value θₐᵥ of the tilts of the bright lines. That is, if the average value θₐᵥ of the tilts of the sheets is larger than the threshold value θₜₕ (θₜₕ: 90°+α<θₐᵥ), the tilting state is determined as “forward tilting (in the conveying direction 41)”.

Conversely, if the average value θₐᵥ of the tilts is smaller than the threshold value θₜₕ (θₜₕ:90°+α>θₐᵥ), the tilting state is determined as “backward tilting (in the conveying direction 41)”. In addition, if the average value θₐᵥ of the tilts is within the range of the threshold value θₜₕ (θₜₕ=θₐᵥ:90°−α≦θₐᵥ≦90°+α), the tilting state is determined as “usual”.

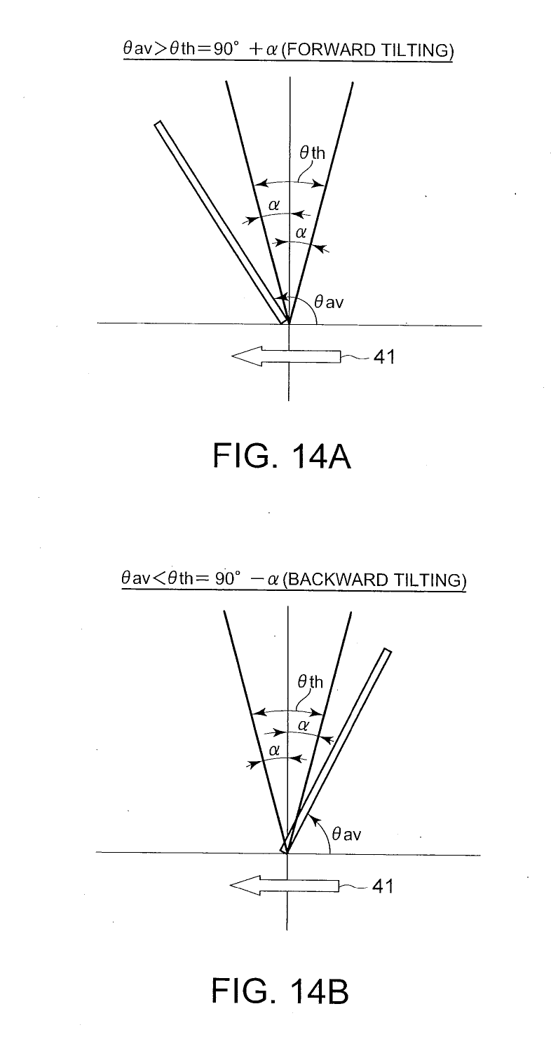

Here, the relation among the above-described determination of “forward tilting”, the threshold value θₜₕ and the average value θₐᵥ is shown in FIG. 14A. In addition, the relation among the above-described determination of “backward tilting”, the threshold value θₜₕ and the average value θₐᵥ is shown in FIG. 14B.

After the tilting state of the sheet bundle Ps is determined in ST104, the above-described density of the sheet bundle Ps is determined based on the average value Gₐᵥ of the gaps between the sheets calculated in St101 and the preliminarily set threshold value Gₜₕ (St105) (St106) (St107). Here, as the determination of the density of the sheet bundle Ps is the same as in the first embodiment, the description will be omitted.

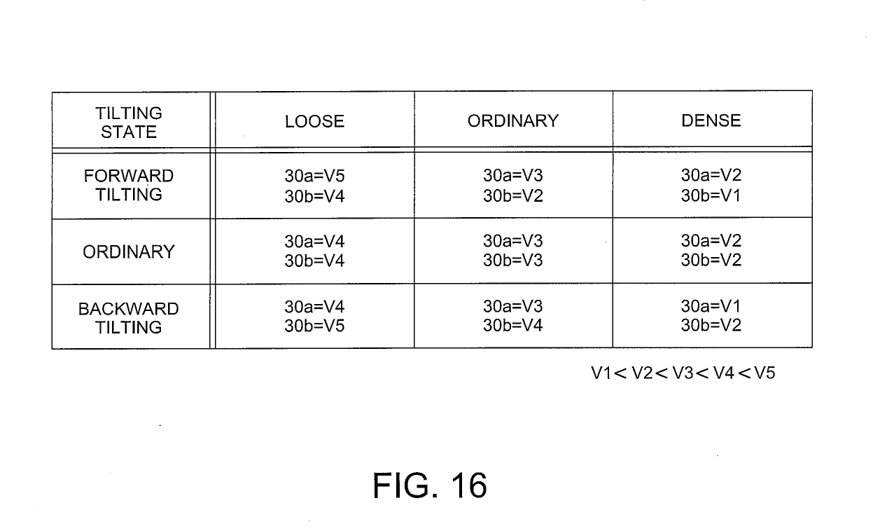

Based on the determination result of the tilting state of the sheet bundle Ps in St104, and the determination result of the density of the sheet bundle Ps in St105 (St106) (St107), the conveying speeds of the downstream side supply conveyor belt 30a and the upstream side supply conveyor belt 30b are controlled as shown in a table of FIG. 16 (St108).

That is, it is designed that the conveying speeds of the downstream side supply conveyor belts 30a and the upstream side supply conveyor belt 30b are controlled in five stages, and the relation of these speeds is set as V1<V2<V3<V4<V5. And when the tilting state is “usual” and the density is also “usual”, the downstream side supply conveyor belts 30a and the upstream side supply conveyor belt 30b are both driven at the conveying speed of V3.

When the tilting state is determined as “forward tilting” in St104, and the density is determined as “usual” in St106, the upstream side supply conveyor belt 30b is kept at V3 and by accelerating the conveying speed of the downstream side supply conveyor belts 30a to V4, the forward tilting state is corrected without changing the density. In addition, when the tilting state is determined as “forward tilting” in St104, and the density is determined as “loose” in St106, by accelerating the conveying speed of the upstream side supply conveyor belt 30b to V4 and by accelerating the conveying speed of the downstream side supply conveyor belt 30a to V5, the loose state is corrected and in addition the forward tilting state is corrected. Conversely, when the tilting state is determined as “forward tilting” in St104, and the density is determined as “dense” in St106, by decelerating the downstream side supply conveyor belts 30a to V2 and by decelerating the conveying speed of the upstream side supply conveyor belt 30b down to V1, the dense state is corrected and in addition the forward tilting state is corrected.

On the other hand, when the tilting state is determined as “backward tilting” in St104, and the density is determined as “usual” in St106, the downstream side supply conveyor belts 30a are kept at V3 and by accelerating the conveying speed of the upstream side supply conveyor belt 30b to V4, the backward tilting state is corrected without changing the density. In addition, when the tilting state is determined as “backward tilting” in St104, and the density is determined as “loose” in St106, by accelerating the upstream side supply conveyor belt 30b to V5, and by accelerating the conveying speed of the downstream side supply conveyor belts 30a up to V4, the loose state is corrected, and in addition the state of backward tilting is corrected. Conversely, when the tilting state is determined as “backward tilting” in St104, and when the density is determined as “dense” in St106, by decelerating the downstream side supply conveyor belts 30a to V2 and by decelerating the conveying speed of the upstream side supply conveyor belt 30b down to V1, the dense state is corrected, and in addition the backward tilting state is corrected.

In addition, when the tilting state is “usual”; by accelerating or decelerating the downstream side supply conveyor belts 30a and the upstream side supply conveyor belt 30b to V4 or to V2 according to the density, respectively, the density is corrected.

That is, when the tilting state of the sheet bundle Ps is determined as “forward tilting” by the determination unit 32, as the lower ends of the sheet bundle Ps existing on the downstream side supply conveyor belts 30a are conveyed at a comparatively fast speed to the downstream side in the conveying direction 41, and in addition the upper ends of the sheet bundle Ps are conveyed in a comparatively slow speed to the downstream side in the conveying direction 41, by controlling the conveying speed of the downstream side supply conveyor belts 30a relatively faster compared with the conveying speed of the upstream side supply conveyor belt 30b, the tilt of the sheets is corrected.

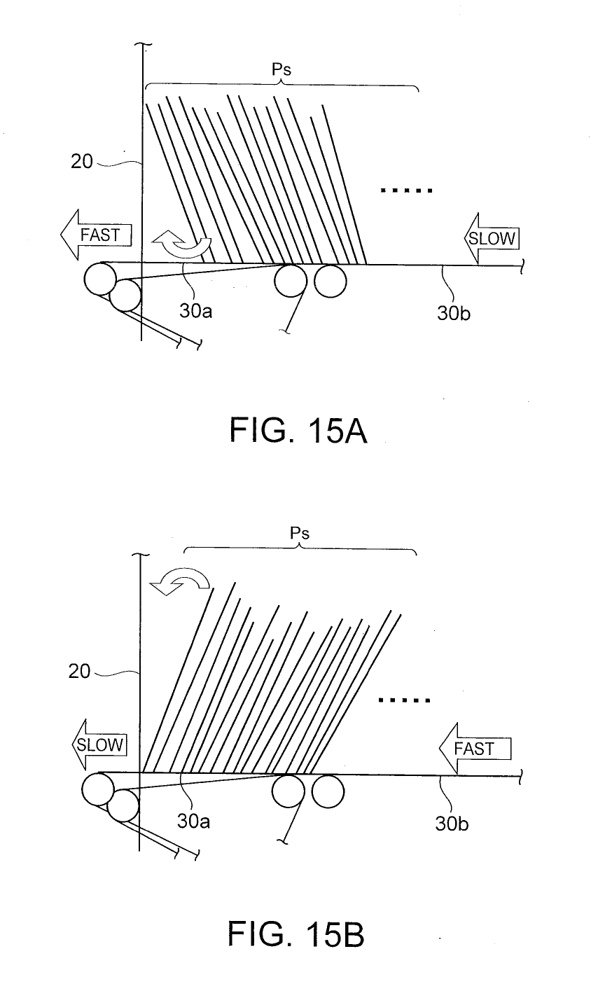

On the other hand, when the tilting state of the sheet bundle Ps is determined as “backward tilting” by the determination unit 32, by controlling the conveying speed of the downstream side supply conveyor belts 30a relatively slower compared with the conveying speed of the upstream side supply conveyor belt 30b, as the lower ends of the sheet bundle Ps existing on the downstream side supply conveyor belt 30a are conveyed in a comparatively slow speed to the downstream side in the conveying direction 41, and in addition the upper ends of the sheet bundle Ps are conveyed in a comparatively fast speed to the downstream side in the conveying direction 41, the tilt of the sheets is corrected. Here, FIG. 15A and FIG. 15B show the relations among the tilting state of the sheet bundle Ps, the conveying speeds of the downstream side supply conveyor belts 30a and the upstream side supply conveyor belt 30b, respectively.

As described above, the second embodiment determines the density and the tilting state of the sheet bundle Ps and keeps the amount of the sheets supplied to the sheet take out belt 20 to be constant, by, correcting the tilting state of the sheets into approximately upright state and in addition making constant the density of the sheet bundle Ps in the vicinity of the sheet take out belt 20.

### Third Embodiment

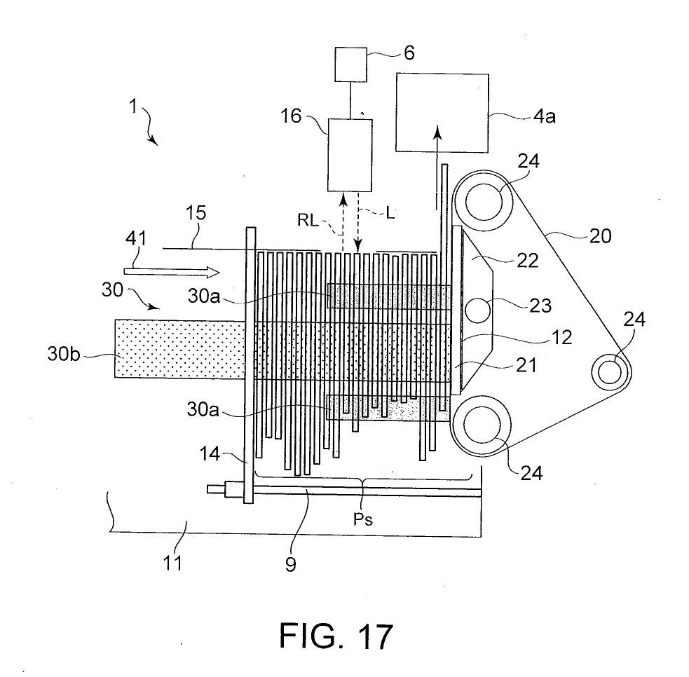

Subsequently, a third embodiment will be described. In the third embodiment, the backup plate 14 is provided slidably to a shaft 9 extending along the conveying direction 41 of the sheet bundle Ps and so that a lower edge of the backup plate 14 contacts with the upstream side supply conveyor belt 30b, as shown in FIG. 17. The third embodiment differs from the second embodiment in a point that the moving speed of the backup plate 14 in the conveying direction 41 along with the conveying speed of the upstream side supply conveyor belt 30b are controlled by the supply conveyor motor (for upstream side use) 34b. In addition, the same reference numerals are given for the same components of the second embodiment, and the duplicated description will be omitted.

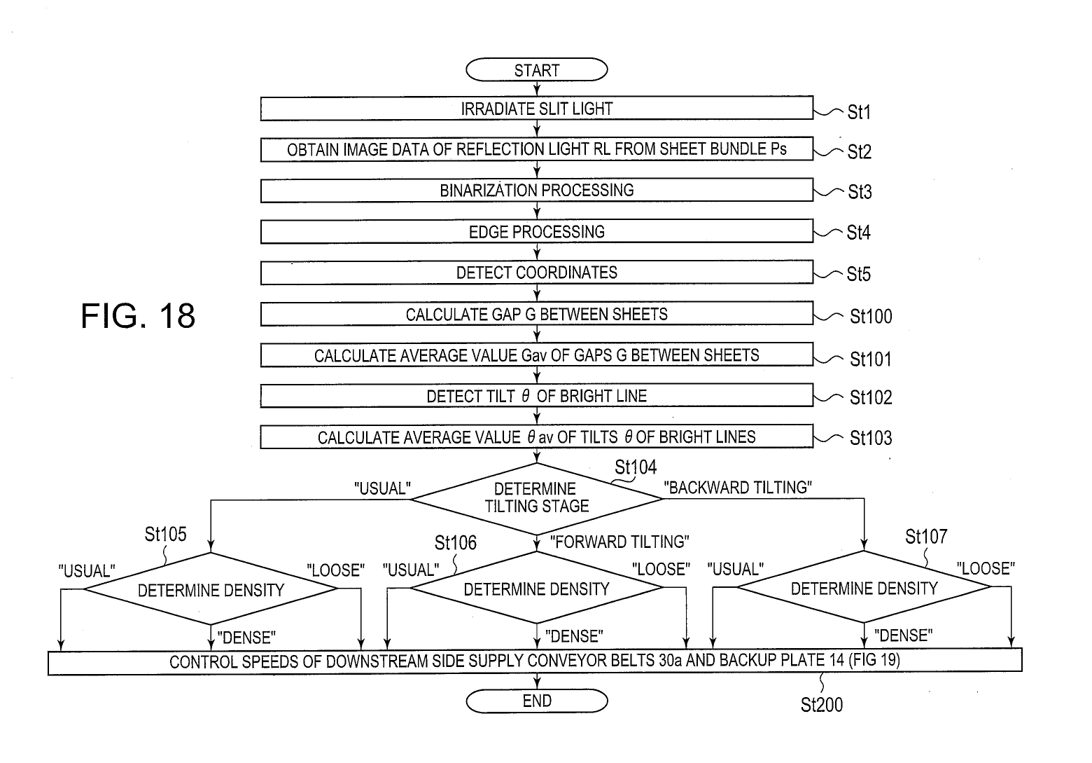

FIG. 18 is a flow chart showing processing of the sheet take out/conveying apparatus 1 according to the third embodiment of the present invention. With respect to St1 to St107 of the second embodiment, as the processing in the third embodiment are performed in the same processing as shown in FIG. 10, the description will be omitted. But in the same manner as the case of the second embodiment, the image data (FIG. 4) obtained in St2 in the first embodiment corresponds to FIG. 11, the image data (FIG. 7) which is edge processed in St4 corresponds to FIG. 12 in the present embodiment, and the image data (FIG. 8) showing the coordinates of the bright points and the end points of the bright lines of the reflection lights RL detected in St5 corresponds to FIG. 13 in the present embodiment.

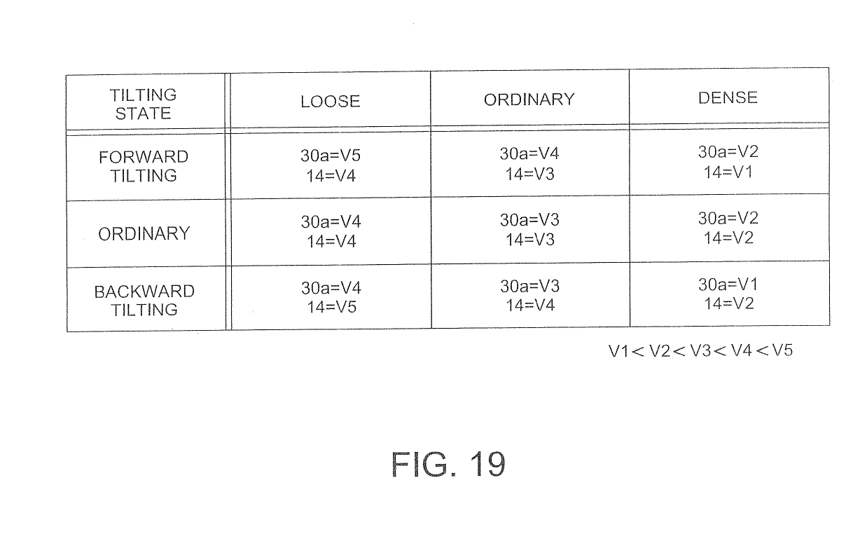

Based on the determination result of the tilting state of the sheet bundle Ps in St104, and the determination result of the density of the sheet bundle Ps in St105 (St106) (St107), the conveying speed of the downstream side supply conveyor belts 30a and the moving speed of the backup plate 14 are controlled as shown in a table of FIG. 19 (St200).

That is, it is designed that the conveying speed of the downstream side supply conveyor belts 30a and the moving speed of the backup plate 14 are controlled in five stages, and the relation of these speeds is set as V1<V2<V3<V4<V5. And when the tilting state is “usual” and the density is also “usual”, the downstream side supply conveyor belts 30a and the backup plate 14 are both driven in the conveying speed of V3.

When the tilting state is determined as “forward tilting” in St104, and the density is determined as “usual” in St106, by accelerating the conveying speed of the downstream side supply conveyor belts 30a to V4 and by keeping the moving speed of the backup plate 14 without change, the forward tilting state is corrected without changing the density. In addition, when the tilting state is determined as “forward tilting” in St104, and the density is determined as “loose” in St106, by accelerating the conveying speed of the downstream side supply conveyor belts 30a to V5 and by accelerating the moving speed of the backup plate to V4, the loose state is corrected, and in addition the forward tilting state is corrected. Conversely, when the tilting state is determined as “forward tilting” in St104, and the density is determined as “dense” in St106, by decelerating the downstream side supply conveyor belts 30a to V2 and by decelerating the moving speed of the backup plate 14 down to V1, the dense state is corrected, and in addition the forward tilting state is corrected.

On the other hand, when the tilting state is determined as “backward tilting” in St104, and the density is determined as “usual” in St106, the conveying speed of the downstream side supply conveyor belts 30a is kept at V3 without change and by accelerating the moving speed of the backup plate 14 to V4, the backward tilting state is corrected without changing the density. In addition, when the tilting state is determined as “backward tilting” in St104, and the density is determined as “loose” in St106, by accelerating the conveying speed of the downstream side supply conveyor belts 30a to V4 and by accelerating the moving speed of the backup plate 14 up to V5, the loose state is corrected, and in addition the backward tilting state is corrected. Conversely, when the tilting state is determined as “backward tilting” in St104, and the density is determined as “dense” in St106, by decelerating the conveying speed of the downstream side supply conveyor belts 30a to V1 and by decelerating the moving speed of the backup plate 14 down to V2, the dense state is corrected, and in addition the backward tilting state is corrected.

In addition, when the tilting state is “usual”, by accelerating or decelerating the conveying speed of the downstream side supply conveyor belts 30a and the moving speed of the backup plate 14 to V4 or to V2 according to the density, respectively, the density is corrected.

That is, when the tilting state of the sheet bundle Ps is determined as “forward tilting” by the determination unit 32, as the lower ends of the sheet bundle Ps existing on the downstream side supply conveyor belts 30a are conveyed in a comparatively fast speed in the conveying direction 41, by controlling the conveying speed of the downstream side supply conveyor belts 30a relatively faster compared with the moving speed of the backup plate 14, the tilt of the sheets is corrected.

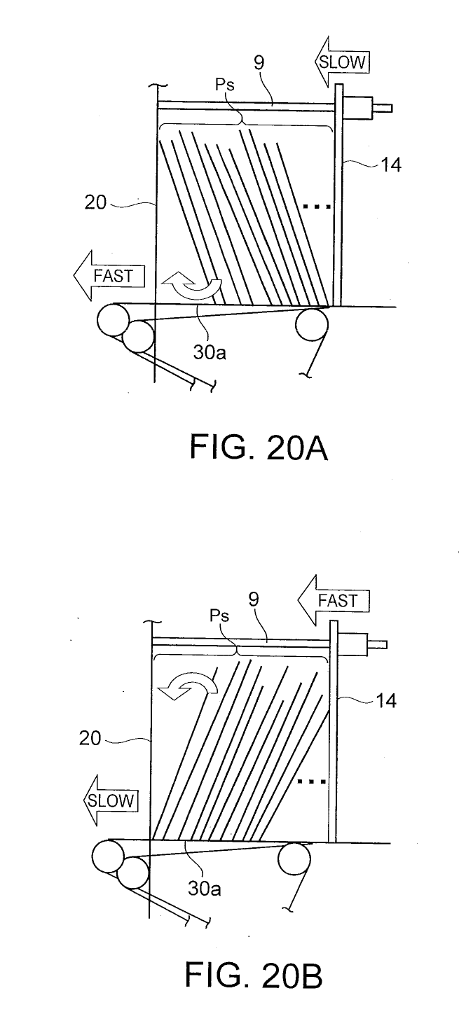

On the other hand, when the tilting state of the sheet bundle Ps is determined as “backward tilting” by the determination unit 32, as the upper ends of the sheet bundle Ps existing on the downstream side supply conveyor belts 30a are pushed out to the downstream side by the backup plate 14 in the conveying direction 41, by controlling the moving speed of the backup plate 14 relatively faster compared with the conveying speed of the downstream side supply conveyor belts 30a, the tilt of the sheets is corrected. Here, FIG. 20A and FIG. 20B show the relation among the tilting state of the sheet bundle Ps, the conveying speed of the downstream side supply conveyor belts 30a and the moving speed of the backup plate 14, respectively.

As described above, the third embodiment determines the density and the tilting state of the sheet bundle Ps, and keeps the amount of the sheets supplied to the sheet take out belt 20 to be constant by correcting the tilting state of the sheets into approximately upright state and making constant the density of the sheet bundle Ps in the vicinity of the sheet take out belt 20.

While certain embodiments have been described, those embodiments have been presented by way of example only, and are not intended to limit the scope of the inventions. Indeed, the novel methods and apparatuses described herein may be embodied in a variety of other forms; furthermore, various omissions, substitutions and changes in the form of the methods and apparatuses described herein may be made without departing from the spirit of the inventions. The accompanying claims and their equivalents are intended to cover such forms or modifications as would fall within the scope and spirit of the inventions.

What is claimed is:

1. An apparatus for determining a state of stacked sheets composed of a plurality of sheets loaded on a table in a standing state, comprising:
an illumination unit to irradiate a slit light onto side faces of the stacked sheets;
a light receiving portion to receive a reflection light of the slit light irradiated by the illumination unit from the stacked sheets;
a detecting unit to detect edges of the sheets based on the reflection light that is reflected from the stacked sheets and received by the light receiving portion; and
a determination unit to determine a state of the stacked sheets based on the edges detected by the detecting unit.

2. The apparatus of claim 1, wherein the determination unit calculates distances between the edges of the adjacent sheets based on the edges detected by the detecting unit, and determines a density of the stacked sheets based on the distances calculated.

3. The apparatus of claim 1, wherein the slit light irradiated by the illumination unit has a definite width.

4. The apparatus of claim 3, wherein the determination unit calculates a tilt of the edges of the stacked sheets based on the edges detected by the detecting unit, and determines a tilting state of the stacked sheets based on the tilts calculated.

5. The apparatus of claim 4, wherein the determination unit calculates the tilt of the edges of the sheets based on an orthogonal projection component of the edges orthogonally projected onto the table and an orthogonal projection component of the edges orthogonally projected onto a plane perpendicular to the table.

6. The apparatus of claim 3, wherein the determination unit calculates a distance between end portions of the adjacent sheets based on the end portions detected by the detecting unit, determines a density of the stacked sheets based on the distances calculated, calculates a tilt of the edges of the stacked sheets based on the edges detected by the detecting unit, and determines a tilting state of the stacked sheets based on the tilts calculated.

7. The apparatus of claim 6, wherein the determination unit calculates the tilt of the edges of the sheets based on an orthogonal projection component of the edges orthogonally projected onto the table and an orthogonal projection component of the edges orthogonally projected onto a plane perpendicular to the table.

8. The apparatus of claim 1, wherein the illumination unit irradiates the slit light onto the stacked sheets with a prescribed angle.

9. A sheet handling apparatus, comprising:
a table to load stacked sheets composed of a plurality of sheets in standing state;
a sheet conveying device to convey the stacked sheets loaded on the table;
a sheet take out device positioned at a terminal end of the sheet conveying device to take out the stacked sheets conveyed to the terminal end one by one;
an illumination unit to irradiate a slit light onto side faces of the stacked sheets in the vicinity of the sheet take out device;
a light receiving portion to receive a reflection light of the slit light irradiated by the illumination unit from the stacked sheets;
a detecting unit to detect edges of the sheets based on the reflection light that is reflected from the stacked sheets and received by the light receiving portion;
a determination unit to determine a state of the stacked sheets based on the edges detected by the detecting unit; and
a controller to control a conveying speed of the sheets by the sheet conveying device based on the state of the stacked sheets determined by the determination unit.

10. The apparatus of claim 9, wherein the determination unit calculates distances between the edges of the adjacent sheets based on the edges detected by the detecting unit, and determines a density of the stacked sheets based on the distances calculated, and
wherein the controller controls the conveying speed of the sheets by the sheet conveying device based on the determined density of the stacked sheets.

11. The apparatus of claim 9, wherein the slit light irradiated by the illumination unit has a definite width.

12. The apparatus of claim 11, wherein the determination unit calculates a tilt of the edges of the stacked sheets based on the edges detected by the detecting unit, and determines a tilting state of the stacked sheets based on the tilts calculated, and
wherein the controller controls the conveying speed of the sheets by the sheet conveying device based on the determined tilting state of the stacked sheets.

13. The apparatus of claim 12, wherein the determination unit calculates the tilt of the edges of the sheets based on an orthogonal projection component of the edges to the table and an orthogonal projection component of edges in a direction perpendicular to the table.

14. The apparatus of claim 9, wherein the determination unit calculates distances between edges of the adjacent sheets based on the edges detected by the detecting unit, determines a density of the stacked sheets based on the distances calculated, calculates a tilt of the edges of the stacked sheets based on the edges detected by the detecting unit, and determines a tilting state of the stacked sheets based on the tilts calculated, and
wherein the controller controls the conveying speed of the sheets by the sheet conveying device based on the determined density of the stacked sheets and the determined tilting state of the stacked sheets.

15. A method for determining a state of stacked sheets composed of a plurality of sheets loaded on the table in a standing state, comprising:
irradiating a slit light onto side faces of the stacked sheets;
receiving a reflection light of the slit light irradiated from the stacked sheets;
detecting edges of the sheets based on the received reflection light that is reflected from the stacked sheets; and
determining a state of the stacked sheets based on the detected edges.

16. The method of claim 15, wherein the determining a state includes:
calculating distances between edges of the adjacent sheets based on the detected edges; and
determining a density of the stacked sheets based on the calculated distances.

17. The method of claim 15, wherein the irradiated slit light has a definite width.

18. The method of claim 17, wherein the determining a state includes:
calculating a tilt of the edges of the stacked sheets based on the detected edges; and
determining a tilting state of the stacked sheets based on the calculated tilt.

19. The method of claim 18, wherein the calculating a tilt calculates the tilt of the edges of the sheets based on an orthogonal projection component of the edges to the table and an orthogonal projection component of the edges in a direction perpendicular to the table

20. The method of claim 17, wherein the determining a state further includes:
calculating distances between the edges of the adjacent sheets based on the detected edges;
determining a density of the stacked sheets based on the calculated distance;
calculating a tilt of the edges of the stacked sheets based on the detected edges; and
determining a tilting state of the stacked sheets based on the calculated tilt.
